(19) United States
(12) Patent Application Publication
(10) Pub. No.: US 2006/0228459 A1
(43) Pub. Date: Oct. 12, 2006

(54) Compositions comprising a cocoa butter component and an animal-derived fat component

(75) Inventors: Ronald Eugene Tribelhorn, Clayton, OH (US); John Leslie Brent JR., Springboro, OH (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(73) Assignee: The Iams Company

(21) Appl. No.: 11/354,432

(22) Filed: Feb. 15, 2006

Related U.S. Application Data
(60) Provisional application No. 60/670,124, filed on Apr. 11, 2005.

(51) Int. Cl. A23D 9/00

(52) U.S. Cl. 426/601

(57) ABSTRACT

Compositions comprising a lipid component which comprises a cocoa butter component and an animal-derived fat component surprisingly mimic certain properties of chocolate and exhibit other unique properties useful for various applications as food compositions, particularly pet food compositions.

### CROSS REFERENCE TO RELATED APPLICATIONS

This application claims the benefit of U.S. Provisional Application No. 60/670,124, filed Apr. 11, 2005.

### FIELD OF THE INVENTION

The present invention is directed to compositions comprising a lipid component which comprises a cocoa butter component and an animal-derived fat component. The compositions of the invention surprisingly mimic certain properties of chocolate and exhibit other unique properties useful for various applications as food compositions, particularly pet food compositions.

### BACKGROUND OF THE INVENTION

Many approaches have been taken to develop pet food compositions that have greater appeal for both the pet and the pet caregiver. These approaches include, for example, pet food compositions having a variety textures and moisture contents, or pet food compositions having multiple components of varying textures or consistencies. Such compositions may be in the form of nutritionally balanced daily feed, or in the form of supplements (e.g, treats), which may or may not be nutritionally balanced.

Pet foods in recent years have also been modified to address specific biological functions of pets. For example, pet food compositions have been developed with the aim of improving health, lengthening life span, improving coat appearance, reducing the chance of illness, and reducing the effects of aging. One challenge to developing pet food compositions containing components which aid in certain biological functions of a pet is the ability to preserve those components for sufficient periods of time in order to deliver the desired benefit to the pet upon digestion of the composition.

It has been found that the compositions of the present invention having a lipid component comprising a cocoa butter component and an animal-derived fat component are useful in providing compositions that surprisingly mimic certain properties of chocolate and are useful in a variety of pet food applications. The compositions of the invention provide a palatable pet food composition which may be administered alone, or in combination with other known pet food compositions, to provide a unique feeding experience which appeals to both the pet and pet caregiver alike. In addition, the compositions of the invention may optionally be used to deliver environmentally sensitive components which aid in certain biological functions of a pet.

### SUMMARY OF THE INVENTION

The present invention relates to compositions comprising a lipid component comprising a cocoa butter component and an animal-derived fat component. Optionally, the compositions of the present invention may comprise about 10% or less of a sweetener, by weight of the composition.

### DETAILED DESCRIPTION OF THE INVENTION

Various documents including, for example, publications and patents, are recited throughout this disclosure. All such documents are, in relevant part, hereby incorporated by reference. The citation of any given document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

All percentages and ratios are calculated by weight unless otherwise indicated. All percentages and ratios are calculated based on the total composition unless otherwise indicated.

Referenced herein are trade names for components including various ingredients utilized in the present invention. The inventors herein do not intend to be limited by materials under a certain trade name. Equivalent materials (e.g., those obtained from a different source under a different name or reference number) to those referenced by trade name may be substituted and utilized in the descriptions herein.

In the description of the invention various embodiments or individual features are disclosed. As will be apparent to the ordinarily skilled practitioner, all combinations of such embodiments and features are possible and can result in preferred executions of the present invention.

The compositions herein may comprise, consist essentially of, or consist of any of the features or embodiments as described herein.

While various embodiments and individual features of the present invention have been illustrated and described, various other changes and modifications can be made without departing from the spirit and scope of the invention. As will also be apparent, all combinations of the embodiments and features taught in the foregoing disclosure are possible and can result in preferred executions of the invention.

As used herein, the term “pet” means a domestic animal including, but not limited to, domestic dogs, cats, horses, cows, ferrets, rabbits, pigs, and the like. Domestic dogs and cats are preferred herein.

As used herein, the term “pet food composition” means a composition that is intended for ingestion by the pet. Pet food compositions may include, without limitation, nutritionally balanced compositions suitable for daily feed, as well as supplements (e.g., treats) which may or may not be nutritionally balanced.

### Compositions of the Present Invention

The compositions of the present invention comprise a lipid component comprising a cocoa butter component and an animal-derived fat component.

In one embodiment, the lipid component comprises the cocoa butter component and the animal-derived fat component at a ratio of from about 5:95 to about 50:50, by weight. In another embodiment herein, the lipid component comprises the cocoa butter component and the animal-derived fat component at a ratio of from about 20:80 to about 45:55, or from about 25:75 to about 40:60, all by weight.

The cocoa butter component and the animal-derived fat component are described as follows:

The present compositions comprise a cocoa butter component which is defined herein as a component comprising one or more of cocoa butter, a cocoa butter extender, a cocoa butter replacer, or a cocoa butter substitute. A given fat may be classified as one of a cocoa butter extender, cocoa butter replacer, or cocoa butter substitute, or sometimes may be classified as two or more of a cocoa butter extender, cocoa butter replacer, and cocoa butter substitute. Where used, each of the cocoa butter extender, cocoa butter replacer, and cocoa butter substitute may be one particular fat within the referenced class or any mixtures of such fats.

Cocoa butter is commonly known in the art and may generally refer to the fat from cocoa beans used to prepare chocolate. Cocoa beans are obtainable from the pods of cacao trees (e.g, Theobroma cacao).

The cocoa butter component may additionally or alternatively comprise a cocoa butter extender. These extenders are also commonly known in the art, and may generally refer to other fats having solid fat index (SFI) profiles which are similar to cocoa butter. Cocoa butter extenders may comprise fat containing C₁₆ or C₁₈ fatty acids, or combinations thereof. Palm oil, shea oil, illipe butter, cottonseed oil, and soybean oil, including fractionated and/or partially hydrogenated forms, are non-limiting examples of cocoa butter extenders.

The cocoa butter component may additionally or alternatively comprise a cocoa butter replacer. These replacers will also be commonly known in the art, and may generally refer to fats having melting or other properties, or structures, similar to those of cocoa butter, which are based on non-lauric fats (e.g, C₁₆ or C₁₈). These include vegetable oils such as palm oil, cottonseed oil, soybean oil, and rapeseed oil, including fractions and/or partially hydrogenated forms thereof. One example is ASTRAL® R (partially hydrogenated vegetable oil (soybean oil and cottonseed oil), commercially available from Humko Oil Products, Cordova, Tenn.).

The cocoa butter component may additionally or alternatively comprise a cocoa butter substitute. These substitutes will also be commonly known in the art, and may generally refer to hard fats having melting or other properties, or structures, similar to those of cocoa butter, but which are based on lauric fats (C₁₂). Such cocoa butter substitutes may tend to have melting points higher than that of cocoa butter, making these substitutes interesting for imparting heat resistance to compositions.

These include vegetable oils such as palm kernel oil and coconut oil, including fractions and/or partially hydrogenated forms thereof.

In one embodiment, the cocoa butter component comprises at least one lipid selected from the group consisting of soybean oil, cottonseed oil, coconut oil, rapeseed oil, palm kernel oil, fractions of the foregoing, and partially hydrogenated forms of the foregoing.

The composition further comprises an animal-derived fat component. As will be commonly known in the art, the animal-derived fat component comprises a fat derived from an animal. Non-limiting examples include butter oil, chicken fat, lard, and tallow.

In one embodiment herein, the compositions comprise about 10% or less of a sweetener, by weight of the composition. Optionally, the compositions herein comprise about 5% or less of the sweetener, or about 2% or less of the sweetener, or about 1% or less of the sweetener, all by weight of the composition.

Sweeteners may include caloric sweeteners such as monosaccharides and disaccharides. Examples of sweeteners include sucrose, fructose, and glucose. Fructose can be obtained or provided as liquid fructose, high fructose corn syrup, dry fructose or fructose syrup, but is preferably provided as high fructose corn syrup. High fructose corn syrup (HFCS) is commercially available as HFCS-42, HFCS-55 and HFCS-90, which comprise 42%, 55% and 90%, respectively, by weight of the sugar solids therein, as fructose.

The sweetener may also include a non-caloric sweetener. Non-limiting examples of non-caloric sweeteners include aspartame, saccharin, cyclamates, acesulfame K, L-aspartyl-L-phenylalanine lower alkyl ester sweeteners, L-aspartyl-D-alanine amides such as, for example, those disclosed in U.S. Pat. No. 4,411,925, L-aspartyl-D-serine amides such as, for example, those disclosed in U.S. Pat. No. 4,399,163, L-aspartyl-hydroxymethyl alkane amide sweeteners such as, for example, those disclosed in U.S. Pat. No. 4,338,346, L-aspartyl-1-hydroxyethylalkane amide sweeteners such as, for example, those disclosed in U.S. Pat. No. 4,423,029, glycyrrhizins, and synthetic alkoxy aromatics.

In one embodiment herein, the compositions are useful for the protection of one or more environmentally sensitive components, such as probiotic microorganisms, vitamins, minerals, and the like. For example, the probiotic microorganism may be selected from one or more yeast or bacterial microorganisms suitable for mammalian consumption and which is able to improve the microbial balance in the host. Various probiotic microorganisms known in the art are suitable for use in the present invention. See, for example, WO 03/075676, Societe Des Produits Nestle, published Sep. 18, 2003.

In one embodiment of the invention, the probiotic component is selected from the group consisting of bacteria of the genera Bacillus, Bacteroides, Bifidobacterium, Enterococcus (e.g., Enterococcus faecium DSM 10663), Lactobacillus, and Leuconostoc, and combinations thereof. In another embodiment of the invention, the probiotic is selected from bacteria of the genera Bifidobacterium, Lactobacillus, and combinations thereof.

Non-limiting examples of lactic acid bacteria suitable for use herein include strains of Streptococcus lactis, Streptococcus cremoris, Streptococcus diacetylactis, Streptococcus thermophilus, Lactobacillus bulgaricus, Lactobacillus acidophilus (e.g., Lactobacillus acidophilus strain DSM 13241), Lactobacillus helveticus, Lactobacillus bifidus, Lactobacillus casei, Lactobacillus lactis, Lactobacillus plantarum, Lactobacillus rhamnosus, Lactobacillus delbruekii, Lactobacillus thermophilus, Lactobacillus fermentii, Lactobacillus salivarius, Lactobacillus reuteri, Bifidobacterium longum, Bifidobacterium infantis, Bifidobacterium bifidum, Bifidobacterium animalis, Bifidobacterium pseudolongum, and Pediococcus cerevisiae, or mixtures thereof, preferably Lactobacillus salivarius, Bifidobacterium infantis, or mixtures thereof.

As a non-limiting example, strains of Bifidobacterium isolated from resected and washed human gastrointestinal tract as disclosed in WO 00/42168 are preferred. For example, the Bifidobacterium infantis strain designated UCC35624 may be used, described as being deposited at the National Collections of Industrial and Marine Bacteria Ltd (NCIMB) on Jan. 13, 1999, and accorded the accession number NCIMB 41003. Strains isolated from resected and washed canine or feline gastrointestinal tract may be particularly useful.

As another non-limiting example, strains of Lactobacillus salivarius isolated from resected and washed human gastrointestinal tract as described in WO 98/35014 are preferred. More preferred are the Lactobacillus salivarius strains that are designated UCC 1 and UCC 118, described as being deposited at the National Collections of Industrial and Marine Bacteria Ltd (NCIMB) on Nov. 27, 1996, and accorded the accession numbers NCIMB 40830 and 40829, respectively.

One or more other optional components may be utilized in the present compositions. For example, the lipid component herein is uniquely advantageous for use herein as a component of a pet food composition. The pet food composition may be of any form, preferably a form which is orally administrable. For example, the composition may be a nutritionally balanced pet food composition or, alternatively, a supplement. As used herein, the term “nutritionally balanced,” with reference to a pet food composition, means that the composition has known required nutrients to sustain life in proper amounts and proportion based on recommendations of recognized authorities in the field of companion animal nutrition. Nutritionally balanced pet food compositions are readily understood in the art, for example, dry foods, semi-moist foods, and wet foods, all utilized as pet daily foods. In one embodiment, the pet food compositions may comprise, on a dry matter basis, from about 20% to about 50% protein, or from about 22% to about 40% protein, by weight of the food composition. As another example, the food compositions may comprise, on a dry matter basis, from about 5% to about 35% fat, or from about 10% to about 30% fat, by weight of the food composition.

Supplements may include chews, gravies (or other toppers), yogurts, or other forms. While supplements are not typically nutritionally balanced, it is certainly acceptable if such supplements are nutritionally balanced. In another embodiment, supplement compositions such as chews and other treats may comprise, on a dry matter basis, from about 20% to about 50% protein, or from about 22% to about 40% protein, by weight of the supplement composition. As another example, these types of supplement compositions may comprise, on a dry matter basis, from about 5% to about 35% fat, or from about 10% to about 30% fat, by weight of the supplement composition. As yet another example, supplement compositions such as gravies or other food toppings may often comprise from about at least about 0.5% protein, or at least about 0.8% protein, by weight of the supplement composition. As yet another example, supplement compositions such as gravies or other food toppings may often comprise from about at least about 1% fat, or at least about 2% fat, or from about 1% to about 5% fat, by weight of the supplement composition. As yet another example, supplement compositions such as gravies or other food toppings may often comprise from about at least about 50% moisture, or at least about 70% moisture, or from about 70% to about 99% moisture.

### Properties of the Compositions and Components Herein

The present compositions or components utilized therein may exhibit defined properties which are expressed by the complete melting point or Solid Fat Index (SFI).

Melting point refers to the temperature at which a component changes from the solid to the liquid phase. As used herein, the complete melting point is the temperature at which the last visible traces of solids disappear. As also used herein, the complete melting point of a given composition or component is measured in accordance with AOCS Method Cc 1-25 (American Oil Chemists' Society).

In yet another embodiment, the lipid component has a complete melting point of about 30° C. or higher. In yet another embodiment, the lipid component has a complete melting point of about 34° C. or higher or 37° C. or higher.

In yet another embodiment, the cocoa butter component has a complete melting point of about 30° C. or higher. In yet another embodiment, the cocoa butter component has a complete melting point of about 34° C. or higher or 37° C. or higher. Solid Fat Index (SFI) is another property which may be exhibited by the compositions or components herein. The SFI relates to the percent of composition or component that is solid at a given temperature. As used herein, the SFI of a given composition or component is measured in accordance with AOCS Method Cd 10-57 (American Oil Chemists' Society).

In one embodiment herein, the cocoa butter component has a particular Solid Fat Index (SFI). As will be well-known and readily measured in the art, the SFI is an approximation of the amount of solids in a particular component at a given temperature. In one embodiment, the cocoa butter component has a Solid Fat Index (SFI) selected from:
(a) SFI at about 38° C. of from 0 to about 20% solids; or from 0 to about 15% solids; or from 0 to about 10% solids;
(b) SFI at about 33° C. of from about 15% to about 45% solids; of from about 15% to about 30% solids;
(c) SFI at about 27° C. of from about 40% to about 55% solids; or from about 40% to about 50% solids;
(d) SFI at about 21° C. of from about 50% to about 65% solids; or from about 50% to about 60% solids;
(e) SFI at about 10° C. of greater than about 55% solids; or of greater than about 60% solids; and
(f) combinations thereof.

In one embodiment, the cocoa butter component has a SFI of two or more, three or more, four, or all five of selections (a)-(e) directly above.

### EXAMPLES

These examples are provided to illustrate the invention and are not intended to limit the scope thereof in any manner. The following compositions are separately prepared, utilizing the indicated components at the approximate indicated amounts (provided as weight percent, by weight of the total composition). The composition is prepared in accordance with methods which are well-known in the art.

| Component | Example 1 | Example 2 | Example 3 |
|---|---|---|---|
| Fiber Component* | 9.8 | 6.78 | 6.78 |
| Dried Egg | 3.9 | 1.08 | 1.08 |
| Poultry Fat | 21.6 | 27.09 | 27.09 |
| Starch Component** | 9.8 | 6.78 | 6.78 |
| Cocoa Butter Replacer | 15.7 | 10.84 | 10.84 |
| Hydrolyzed Protein | remainder | 27.1 | 27.1 |
| Flavor Component*** | 0 | remainder | Remainder |
| | | (meat digest) | (peanut meal) |

*the fiber component may comprise a single fiber source or a combination of fiber sources that typically provides both soluble and insoluble fiber to a pet diet. Fiber sources may include, for example, celluloses, gums, beet pulp, and the like.
**sources of modified starch may include, for example, cereals, modified starches, and dextrinized starches (e.g., maltodextrins).
***for pet food compositions, the flavor component may comprise digests derived from meats and meat by-products, or other sources such as peanut meals and peanut butters.

The compositions described above may be utilized in a number of forms such as pet food compositions. For example, a composition may be utilized to partially or totally enrobe a kibble, biscuit, or other conventional base to prepare a pet food supplement. In the enrobing process, the heated composition may be sprayed on the conventional base, or the base may be dipped into a heated mass of the mixture. Alternatively, the heated composition may be drizzled over the conventional base to either uniformly coat the base or coat in the form of a design on the surface of the base.

In another embodiment, the compositions may be filled inside of a hard or semi-moist conventional shell to provide a pet food composition. Once filled, the shell may be either crimped or may be provided with one or more open ends.

In yet another embodiment, the compositions may be prepared as a dressing for use as a topper to nutritionally balanced pet food diets. The dressing may be packaged within a sachet or other containing device. The dressing may be optionally heated prior to application to the diet, in order to render the composition more fluid in nature.

What is claimed is:

1. A composition comprising a lipid component, wherein the lipid component comprises a cocoa butter component and an animal-derived fat component at a ratio of from about 5:95 to about 50:50, by weight.

2. The composition according to claim 1 which is a pet food composition comprising about 10% or less of a sweetener, by weight of the composition.

3. The composition according to claim 2 wherein the cocoa butter component comprises at least one lipid selected from the group consisting of soybean oil, cottonseed oil, coconut oil, rapeseed oil, palm kernel oil, fractions of the foregoing, and partially hydrogenated forms of the foregoing.

4. The composition according to claim 2 wherein the lipid component has a complete melting point of about 30° C. or higher.

5. The composition according to claim 4 wherein the cocoa butter component has a complete melting point of about 30° C. or higher.

6. The composition according to claim 4 wherein the cocoa butter component comprises at least one lipid selected from the group consisting of soybean oil, cottonseed oil, coconut oil, rapeseed oil, palm kernel oil, fractions of the foregoing, and partially hydrogenated forms of the foregoing.

7. The composition according to claim 4 wherein the lipid component comprises the cocoa butter component and the animal-derived fat component at a ratio of from about 20:80 to about 45:55, by weight.

8. The composition according to claim 5 wherein the lipid component has a complete melting point of about 34° C. or higher.

9. The composition according to claim 7 wherein the lipid component comprises the cocoa butter component and the animal-derived fat component at a ratio of from about 25:75 to about 40:60, by weight.

10. The composition according to claim 8 wherein the lipid component has a complete melting point of about 37° C. or higher.

11. The composition according to claim 10 wherein the cocoa butter component comprises at least one lipid selected from the group consisting of soybean oil, cottonseed oil, coconut oil, rapeseed oil, palm kernel oil, fractions of the foregoing, and partially hydrogenated forms of the foregoing.

12. A composition comprising a lipid component, wherein the lipid component comprises a cocoa butter component and an animal-derived fat component, wherein the lipid component has a complete melting point of about 30° C. or higher.

13. The composition according to claim 10 which is a pet food composition comprising about 10% or less of a sweetener, by weight of the composition.

14. The composition according to claim 11 wherein the cocoa butter component comprises at least one lipid selected from the group consisting of soybean oil, cottonseed oil, coconut oil, rapeseed oil, palm kernel oil, fractions of the foregoing, and partially hydrogenated forms of the foregoing.

15. The composition according to claim 12 wherein the cocoa butter component has a complete melting point of about 30° C. or higher.

16. The composition according to claim 13 wherein the lipid component comprises the cocoa butter component and the animal-derived fat component at a ratio of from about 20:80 to about 45:55, by weight.

17. The composition according to claim 13 wherein the lipid component has a complete melting point of about 34° C. or higher.

18. The composition according to claim 15 wherein the lipid component comprises the cocoa butter component and the animal-derived fat component at a ratio of from about 25:75 to about 40:60, by weight.

19. The composition according to claim 16 wherein the cocoa butter component has a complete melting point of about 34° C. or higher.

20. The composition according to claim 19 wherein the cocoa butter component comprises at least one lipid selected from the group consisting of soybean oil, cottonseed oil, coconut oil, rapeseed oil, palm kernel oil, fractions of the foregoing, and partially hydrogenated forms of the foregoing.

21. A composition comprising a lipid component, wherein the lipid component comprises a cocoa butter component and an animal-derived fat component, wherein the cocoa butter component has a complete melting point of about 30° C. or higher.

22. The composition according to claim 18 which is a pet food composition comprising about 10% or less of a sweetener, by weight of the composition.

23. The composition according to claim 19 wherein the cocoa butter component comprises at least one lipid selected from the group consisting of soybean oil, cottonseed oil, coconut oil, rapeseed oil, palm kernel oil, fractions of the foregoing, and partially hydrogenated forms of the foregoing.

24. The composition according to claim 20 wherein the lipid component comprises the cocoa butter component and the animal-derived fat component at a ratio of from about 20:80 to about 45:55, by weight.

25. The composition according to claim 20 wherein the lipid component comprises the cocoa butter component and the animal-derived fat component at a ratio of from about 25:75 to about 40:60, by weight.

26. The composition according to claim 24 wherein the cocoa butter component comprises at least one lipid selected from the group consisting of soybean oil, cottonseed oil, coconut oil, rapeseed oil, palm kernel oil, fractions of the foregoing, and partially hydrogenated forms of the foregoing.

27. A composition comprising a lipid component wherein the lipid component comprises a cocoa butter component and an animal-derived fat component, wherein the cocoa butter component has a Solid Fat Index (SFI) selected from the group consisting of:
(a) SFI at about 38° C. of from 0 to about 20% solids;
(b) SFI at about 33° C. of from about 15% to about 45% solids;
(c) SFI at about 27° C. of from about 40% to about 55% solids;
(d) SFI at about 21° C. of from about 50% to about 65% solids;
(e) SFI at about 10° C. of greater than about 55% solids; and
(f) combinations thereof.

28. The composition according to claim 23 which is a pet food composition comprising about 10% or less of a sweetener, by weight of the composition.

29. The composition according to claim 24 wherein the cocoa butter component has a Solid Fat Index (SFI) selected from the group consisting of:
(a) SFI at about 38° C. of from 0 to about 15% solids;
(b) SFI at about 33° C. of from about 15% to about 30% solids;
(c) SFI at about 27° C. of from about 40% to about 50% solids;
(d) SFI at about 21° C. of from about 50% to about 65% solids;
(e) SFI at about 10° C. of greater than about 60% solids; and
(f) combinations thereof.

30. The composition according to claim 25 wherein the lipid component comprises the cocoa butter component and the animal-derived fat component at a ratio of from about 5:95 to about 50:50, by weight.

31. The composition according to claim 25 wherein the lipid component comprises the cocoa butter component and the animal-derived fat component at a ratio of from about 20:80 to about 45:55, by weight.

32. The composition according to claim 27 wherein the cocoa butter component has a Solid Fat Index (SFI) selected from the group consisting of:
(a) SFI at about 38° C. of from 0 to about 10% solids;
(b) SFI at about 33° C. of from about 15% to about 30% solids;
(c) SFI at about 27° C. of from about 40% to about 50% solids;
(d) SFI at about 21 ° C. of from about 50% to about 60% solids;
(e) SFI at about 10° C. of greater than about 60% solids; and
(f) combinations thereof.

33. The composition according to claim 29 wherein the cocoa butter component has a Solid Fat Index (SFI) selected from the group consisting of:
(a) SFI at about 38° C. of from 0 to about 10% solids;
(b) SFI at about 33° C. of from about 15% to about 30% solids;
(c) SFI at about 27° C. of from about 40% to about 50% solids;
(d) SFI at about 21° C. of from about 50% to about 60% solids;
(e) SFI at about 10° C. of greater than about 60% solids; and
(f) combinations thereof.

34. The composition according to claim 28 wherein the cocoa butter component comprises at least one lipid selected from the group consisting of soybean oil, cottonseed oil, coconut oil, rapeseed oil, palm kernel oil, fractions of the foregoing, and partially hydrogenated forms of the foregoing.

35. The composition according to claim 29 wherein the lipid component comprises the cocoa butter component and the animal-derived fat component at a ratio of from about 25:75 to about 40:60, by weight.

36. The composition according to claim 28 wherein the lipid component has a complete melting point of about 34° C. or higher.
